(19) United States
(12) Patent Application Publication
(10) Pub. No.: US 2017/0285780 A1
(43) Pub. Date: Oct. 5, 2017

(54) TOUCH SENSOR AND METHOD FOR PREPARING THE SAME

(71) Applicant: DONGWOO FINE-CHEM CO., LTD., Iksan-si (KR)

(72) Inventors: Yong Soo PARK, Pyeongtaek-si (KR); Ki Joon PARK, Daegu (KR); Euk Kun YOON, Hwaseong-si (KR); Sang Woong LEE, Yongin-si (KR); Kangjae LEE, Paju-si (KR); Sung Wook CHAE, Pyeongtaek-si (KR)

(73) Assignee: DONGWOO FINE-CHEM CO., LTD., Iksan-si (KR)

(21) Appl. No.: 15/467,094

(22) Filed: Mar. 23, 2017

(30) Foreign Application Priority Data
Mar. 29, 2016 (KR) 10-2016-0037624

(51) Int. Cl. G06F 3/041

(52) U.S. Cl. CPC G06F 3/041; G06F 2203/04103; G06F 2203/04111

(57) ABSTRACT

The present invention relates to a touch sensor and a fabrication method thereof in which sensor electrodes in the active area is connected to the trace via a bridge electrode.

### TECHNICAL FIELD

The present invention relates to a touch sensor and a method for preparing the same. Particularly, the present invention relates to a flexible touch sensor with excellent durability and a method for preparing the same.

### BACKGROUND ART

There have been attempts to introduce a touch input method into a wider variety of electronic devices while the touch input method is being spotlighted as a next generation input method. Accordingly, research and development of a touch sensor which can be applied to various environments and can accurately recognize a touch have been actively performed.

For example, in the case of an electronic device having a touch-type display, an ultra-thin flexible display that achieves ultra-light weight, low power and improved portability has been attracting attention as a next-generation display, and development of a touch sensor applicable to such a display has been desired.

Flexible display means a display made on a flexible substrate that can be bent, folded or rolled without loss of properties, and technology development is under way in the form of flexible LCDs, flexible OLEDs and electronic paper.

Particularly, in the case of a portable electronic device, there are two opposing demands for miniaturization for portability and large-sized display for displaying a large amount of information as much as possible.

In order to secure a maximum display within a given device size, Korean Patent Publication No. 10-2015-0057323 proposes a touch sensor integrated display device having a narrow bezel area. In this method, in order to reduce the area of the bezel, the touch pad is not present in an area passing through the bending lines, thereby preventing cracks or lifting in the connection portion between the touch pad and the terminal. However, even with this method, there is a limitation that the screen size of the device plane cannot be exceeded.

Recently, as disclosed in Korean Patent Publication No. 10-2015-0044870, a portable terminal having a flexible display section divides the flexible display section into a main display region on the front side and a sub-display region on the lateral sides, which employs the lateral sides as a part of display region.

In this case, although there is an advantage of enlarging the display area, there is a problem that stress is accumulated in the transparent conductive film at the edge portion where the display device is bent, thereby causing cracks in the touch sensor.

### DISCLOSURE OF INVENTION

### Technical Problem

It is an object of the present invention to provide a flexible touch sensor having improved bending characteristics and durability capable of withstanding the stress generated in the bent portion of the touch sensor.

Another object of the present invention is to provide a method for preparing a flexible touch sensor having improved bending characteristics and durability capable of withstanding the stress generated in the bent portion of the touch sensor without any additional process.

### Technical Solution

According to one aspect of the present invention, there is provided a touch sensor, comprising: a substrate; an active area in which sensor electrodes are arranged on the substrate; a trace located on a boundary of the active area on the substrate to connect the sensor electrodes to a touch sensor wiring; and at least one trace bridge electrode electrically connecting the sensor electrodes to the trace.

Here, the sensor electrodes may include a plurality of first sensor electrodes arranged in a first direction and connected with each other in one pattern and a plurality of second sensor electrodes arranged in a second direction crossing the first direction and connected with each other via sensor bridge electrodes.

The trace may include a transparent conductive layer made of the same material as the sensor electrodes; and a metal layer, and the trace bridge electrode may electrically connect the sensor electrodes with the transparent conductive layer or electrically connect the sensor electrodes with the metal layer.

The difference in transmissivity of the trace bridge electrode and the sensor electrodes may be 10% or less.

The touch sensor may have a bent shape to form a curved surface around at least a part of the trace.

According to another aspect of the present invention, there is provided a method for preparing a touch sensor comprising the steps of: forming a first conductive pattern including a sensor electrode pattern and a first trace pattern on a substrate; forming a second trace pattern on at least a part of the first trace pattern; applying and patterning an insulation layer for covering at least one of the first conductive pattern and the second trace pattern; and forming a trace bridge electrode electrically connecting at least a part of the sensor electrode pattern to the first or the second trace pattern on the insulation layer.

According to yet another aspect of the present invention, there is provided a method for preparing a touch sensor comprising the steps of: forming a separation layer by applying a composition for forming the separation layer on a carrier substrate; forming a first conductive pattern including a sensor electrode pattern and a first trace pattern on the separation layer; forming a second trace pattern on at least a part of the first trace pattern; applying and patterning an insulation layer for covering at least one of the first conductive pattern and the second trace pattern; and forming a trace bridge electrode electrically connecting at least a part of the sensor electrode pattern to the first or the second trace pattern on the insulation layer.

Here, the sensor electrode pattern may include a plurality of first sensor electrodes arranged in a first direction and connected with each other in one pattern and a plurality of second sensor electrodes arranged in a second direction crossing the first direction and unconnected with each other, and the sensor bridge electrode for connecting the plurality of the second sensor electrode with each other may be formed in the step of forming the trace bridge electrode.

The method for preparing a touch sensor may further comprise the step of forming a passivation layer after the step of forming the trace bridge electrode.

When a carrier substrate is used, the method for preparing a touch sensor may further comprise the step of removing the carrier substrate and attaching a base film after the step of forming the trace bridge electrode.

### Advantageous Effects

According to the touch sensor of the present invention, the stress can be alleviated by connecting the sensor electrode of the active area and the trace through the bridge electrode instead of the continuous film, thereby improving the bending characteristics and durability of the touch sensor and suppressing the occurrence of cracks in the touch sensor.

Since the bridge electrode connecting the sensor electrode and the trace can be formed together in the step of forming sensor bridge electrode of the sensor electrode forming process of the active area, a separate process for forming the bridge electrode connecting the sensor electrode and the trace is not required.

Accordingly, the touch sensor of the present invention is well suited for application to a bent display device that utilizes the front surface as well as lateral surfaces of the display device as a display area.

### DESCRIPTION OF DRAWINGS

FIG. 1 is a plan view of a touch sensor according to an embodiment of the present invention.

FIG. 2 shows a state when the touch sensor according to an embodiment of the present invention is applied to a display device.

FIG. 3 is a sectional view of FIG. 1 along the line III-III′.

FIGS. 4 to 6 are cross-sectional views illustrating a touch sensor according to other embodiments of the present invention.

FIGS. 7a to 7e are cross-sectional views showing a method for preparing a touch sensor according to an embodiment of the present invention.

FIGS. 8a to 8g are cross-sectional views showing a method for preparing a touch sensor according to another embodiment of the present invention.

### BEST MODE

Hereinafter, preferred embodiments of a touch sensor and a method for preparing the same according to the present invention will be described in detail with reference to the accompanying drawings. However, the drawings accompanying the present disclosure are mere examples for describing the present invention, and the present invention is not limited by the drawings. Also, some elements may be exaggerated, scaled-down, or omitted in the drawings for clearer expressions.

The present invention provides a flexible touch sensor with improved bending characteristics and durability that can withstand the stress generated in the bent portion of the touch sensor by connecting the sensor electrode and the trace via the bridge electrode.

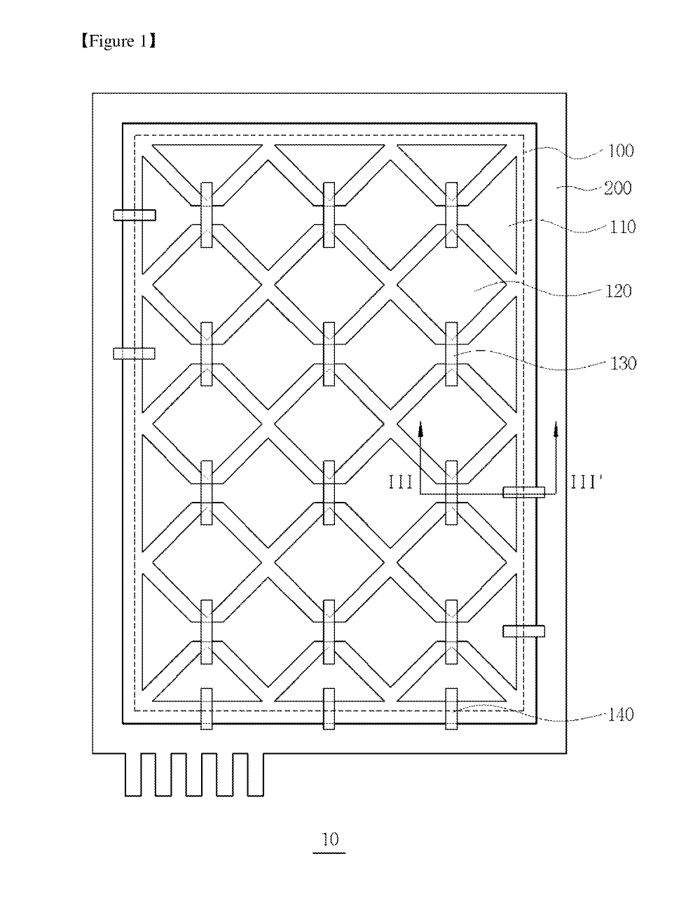

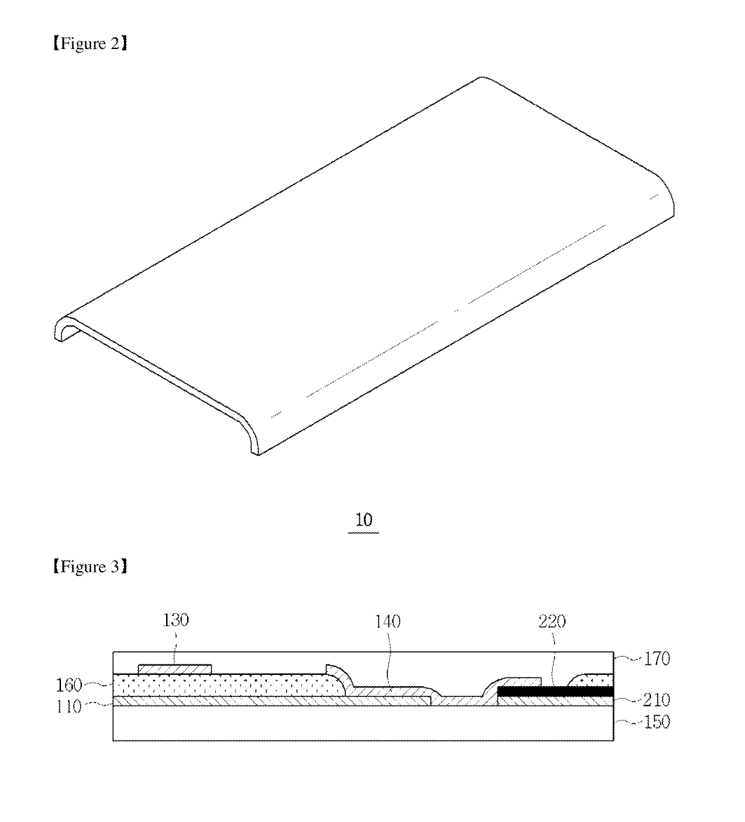

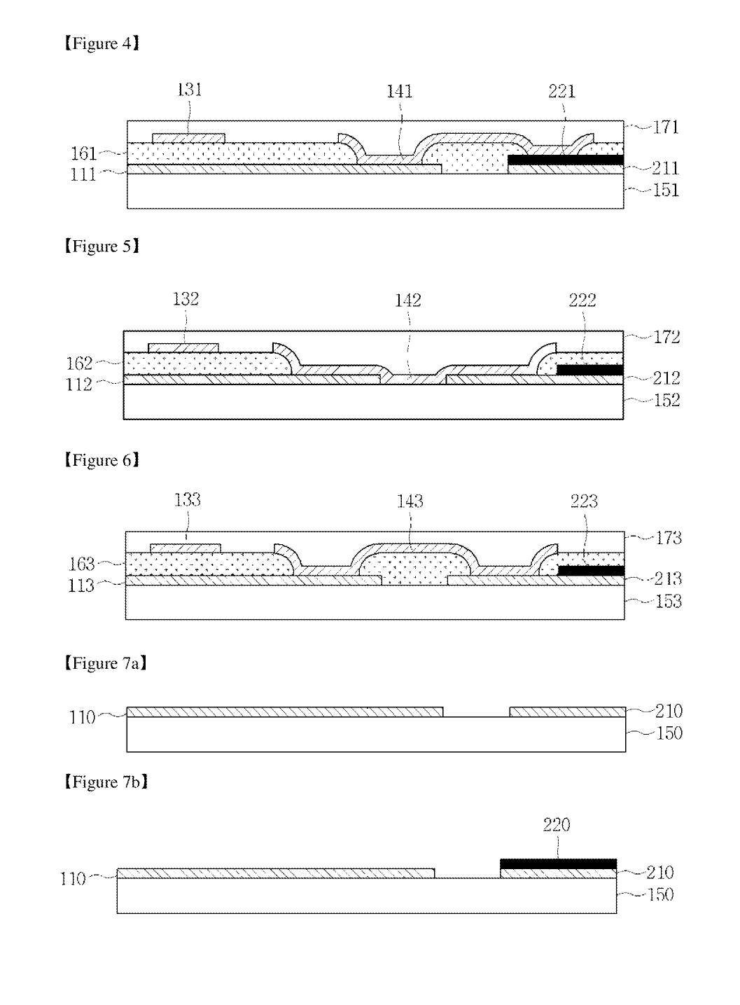

FIG. 1 is a plan view of a touch sensor according to an embodiment of the present invention. FIG. 2 shows a state when the touch sensor according to an embodiment of the present invention is applied to a display device. FIG. 3 is a sectional view of FIG. 1 along the line III-III′. For convenience of explanation, a detailed pattern of the trace is not shown in FIGS. 1 and 3, but only a brief form thereof is shown.

Referring FIGS. 1 and 3, the touch sensor 10 according to an exemplary embodiment of the present invention includes an active area 100 including at least a part of the region capable of sensing a touch and a trace 200 which is disposed at a boundary of the active area 100 and electrically connected to a wiring portion (not shown) of the touch sensor.

A plurality of sensor electrodes 110 and 120 are arranged in the active area 100 for sensing a touch, which includes a plurality of first sensor electrodes arranged in a first direction (horizontal direction in FIG. 1) and connected with each other as a single pattern and a plurality of second sensor electrodes arranged in a second direction crossing the first direction (vertical direction in FIG. 1) and connected with each other via sensor bridge electrodes 130.

The first sensor electrodes 110 and the second sensor electrodes 120 are electrically connected to the trace 200 via trace bridge electrodes 140, and electrically connected to the wiring of the touch sensor in result.

In FIG. 1, the first and second sensor electrodes 110 and 120 have a unit structure in a rhombic shape. However, the present invention is not limited thereto, and it is absolutely possible to configure the sensor electrodes in different forms provided that one sensor electrode belonging to a cell constituting one sensing region is connected to another sensor electrode belonging to another cell constituting another sensing region.

The first sensor electrodes 110 and the second sensor electrodes 120 are formed by a single patterning process on the same side of the substrate 150. Since a plurality of the first sensor electrodes 110 are connected to each other in a single pattern, a plurality of the first sensor electrodes 110 connected to each other and a plurality of the second sensor electrodes 120 belonging to cells forming separate sensing regions are formed through the same patterning process.

The first and second sensor electrodes 110 and 120 are made of a transparent conductive layer, which may be formed of one or more materials selected from metal, metal nanowire, metal oxide, carbon nanotube, graphene, conductive polymer and conductive ink.

Here, the metal may be any one of gold, silver, copper, molybdenum, aluminum, palladium, neodymium, platinum, zinc, tin, titanium, and an alloy thereof.

The metal nanowire may be any one of silver nanowire, copper nanowire, zirconium nanowire, and gold nanowire.

The metal oxide is selected from the group consisting of indium tin oxide (ITO), indium zinc oxide (IZO), indium zinc tin oxide (IZTO), aluminum zinc oxide (AZO), gallium zinc oxide (GZO), fluorine tin oxide (FTO), and zinc oxide (ZnO).

The first and second sensor electrodes 110 and 120 may also be formed of a carbon-based material including carbon nanotube (CNT) or graphene.

The conductive polymer may comprise polypyrrole, polythiophene, polyacetylene, PEDOT, and polyaniline, and the conductive ink may be a mixture of a metal powder and a curable polymeric binder.

In addition, the first and second sensor electrodes 110 and 120 may have a stacked structure of at least two conductive layers in order to reduce electrical resistance.

The first and second sensor electrodes 110 and 120 may be formed of one layer of ITO, AgNW (silver nanowire), or metal mesh as one embodiment. In the case of forming two or more layers, the first electrode layer may be formed of a transparent metal oxide such as ITO and a second electrode layer may be formed on the ITO electrode layer using metal, AgNW or the like in order to further lower the electrical resistance.

The trace 200 is constituted of the first layer 210 made of the same transparent conductive layer as the first and second sensor electrodes 110 and 120 and the second layer 220 made of a metal layer.

The transparent conductive layer 210 of the trace 200 is formed by the same patterning process as the first and second sensor electrodes 110 and 120 on the same side of the substrate 150, and the metal layer 220 constituting the trace 200 is formed thereon.

An insulation layer 160 is formed on the first sensor electrode 110 and the second sensor electrode 120 to electrically isolate the first sensor electrode 110 and the second sensor electrode 120 from each other.

A plurality of the second sensor electrodes 120 belonging to the cells constituting separate sensing areas and separated from each other on the transparent conductive layer pattern are connected to each other through the holes of the insulation layer 160 by the sensor bridge electrode 130.

Meanwhile, some of the outermost sensor electrodes 110 and 120 of the active area 100 are electrically connected to the trace 200, as shown in FIG. 3, through the trace bridge electrode 140 to the metal layer 220 of the trace 200.

The sensor bridge electrode 130 and the trace bridge electrode 140 are also formed using a transparent conductive layer material similar to the first and second sensor electrodes 110 and 120. In particular, the visibility of the sensor and trace bridge electrodes 130 and 140 can be mitigated by making the difference of the transmissivity between the material of the first and second sensor electrodes 110 and 120 and the material of the sensor and trace bridge electrodes 130 and 140 within 10%.

When the touch sensor 10 according to an embodiment of the present invention is applied to a display device, as shown in FIG. 2, the edge of the touch sensor 10 may be bent to maximize the display area.

At this time, stress can be alleviated by connecting the first and second sensor electrodes 110 and 120 of the active area 100 and the trace 200 through the trace bridge electrode 140 instead of the continuous film, thereby improving the bending characteristics and durability of the touch sensor to suppress cracking of the touch sensor.

A passivation layer 170 is formed on the sensor bridge electrode 130 and the trace bridge electrode 140 in order to prevent the conductive pattern constituting the electrode from being affected by the external environment (moisture, air, etc.).

The substrate 150 in which the active area 100 and the trace 200 are positioned is a film substrate for implementing a flexible touch sensor, and may be a transparent film or a polarizing plate.

The transparent film is not limited if it has good transparency, mechanical strength and thermal stability. Specific examples of the transparent film may include thermoplastic resins, e.g., polyester resins such as polyethylene terephthalate, polyethylene isophthalate, polyethylene naphthalate and polybutylene terephthalate; cellulose resins such as diacetylcellulose and triacetylcellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbornene structure, and ethylene-propylene copolymer; vinyl chloride resins; amide resins such as nylon and aromatic polyamide; imide resins; polyethersulfone resins; sulfone resins; polyether ether ketone resins; polyphenylene sulfide resins; vinyl alcohol resins; vinylidene chloride resins; vinyl butyral resins; allylate resins; polyoxymethylene resins; and epoxy resins. Also, a film consisting of a blend of the thermoplastic resins may be used. In addition, thermally curable or UV curable resins such as (meth)acrylate, urethane, acrylic urethane, epoxy and silicon resins may be used.

Such a transparent film may have a suitable thickness. For example, considering workability in terms of strength and handling, or thin layer property, the thickness of the transparent film may range from 1 to 500 μm, preferably 1 to 300 μm, more preferably 5 to 200 μm.

The transparent film may contain at least one suitable additive. Examples of the additive may include an UV absorber, an antioxidant, a lubricant, a plasticizer, a releasing agent, a coloring-preventing agent, an anti-flame agent, a nucleation agent, an anti-static agent, a pigment and a colorant. The transparent film may comprise various functional layers including a hard coating layer, an anti-reflective layer and a gas barrier layer, but the present invention is not limited thereto. That is, other functional layers may also be included depending on the desired use.

If necessary, the transparent film may be surface-treated. For example, the surface treatment may be carried out by drying method such as plasma, corona and primer treatment, or by chemical method such as alkali treatment including saponification.

Also, the transparent film may be an isotropic film, a retardation film or a protective film.

In the case of the isotropic film, it is preferred to satisfy an in-plane retardation (Ro) of 40 nm or less, preferably 15 nm or less and a thickness retardation (Rth) of −90 nm to +75 nm, preferably −80 nm to +60 nm, particularly −70 nm to +45 nm, the in-plane retardation (Ro) and thickness retardation (Rth) being represented by the following equations.

Ro=[(nx−ny)×d]

Rth=[(nx+ny)/2−nz]xd

wherein, nx and ny are each a main refractive index in a film plane, nz is a refractive index in the thickness direction of film, and d is a thickness of film.

The retardation film may be prepared by uniaxial stretching or biaxial stretching of a polymer film, coating of a polymer or coating of a liquid crystal, and it is generally used for improvement or control of optical properties, e.g., viewing angle compensation, color sensitivity improvement, light leakage prevention, or color control of a display.

The retardation film may include a half-wave (½) or quarter-wave (¼) plate, a positive C-plate, a negative C-plate, a positive A-plate, a negative A-plate, and a biaxial plate.

The protective film may be a polymer resin film comprising a pressure-sensitive adhesive (PSA) layer on at least one surface thereof, or a self-adhesive film such as polypropylene.

The polarizing plate may be any one known to be used in a display panel.

Specifically, polyvinyl alcohol (PVA), cellulose triacetate (TAC) or cycloolefin polymer (COP) film may be used, but the present invention is not limited thereto.

Though it is not shown in the drawings, the substrate 150 can be adhered using an adhesive layer, and a photo-curable adhesive may be used. As the photo-curable adhesive does not need a separate drying process after photo curing, the fabrication process is simple. As a result, the productivity increases. In the present invention, photo-curable adhesives available in the art may be used without particular limitation. For example, a composition comprising an epoxy compound or acrylic monomer may be used.

For curing of the adhesive layer, light such as far ultraviolet ray, ultraviolet ray, near ultraviolet ray, and infrared ray, electromagnetic wave such as X ray, and y ray may be used, and electron beam, proton beam, neutron beam as well. However, UV curing is advantageous in terms of curing speed, availability of curing device, cost, and so on.

A high pressure mercury lamp, electrodeless lamp, extra high pressure mercury lamp, carbon arc lamp, xenon lamp, metal halide lamp, chemical lamp, black light and the like can be used as a light source of UV curing.

The connection of the sensor electrode and the trace through the trace bridge electrode can be done in a variety of ways.

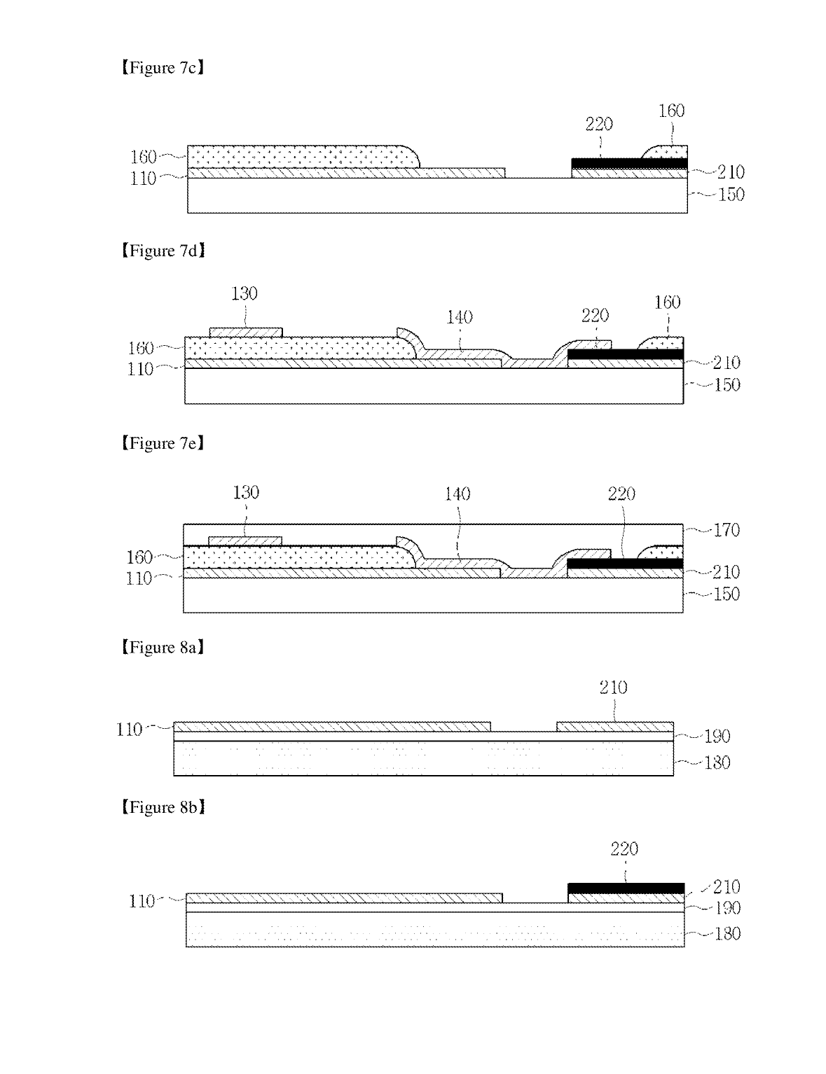

FIGS. 4 to 6 are cross-sectional views illustrating touch sensors according to other embodiments of the present invention formed in various other ways for connecting a sensor electrode to a trace.

First, referring to FIG. 4, the structure of the sensor electrode 111 and the trace 211 and 221 formed on the substrate 151 is similar to the embodiment shown in FIG. 2, but the insulation layer 161 is patterned in a manner different from the embodiment shown in FIG. 2.

That is, after the insulation layer 161 is formed to cover the sensor electrode 111 and the trace 211 and 221 located at the boundary of the active area, the trace bridge electrode 141 connects the sensor electrode 111 with the metal layer 221 of the trace through the hole of the insulation layer.

It is also possible to connect the sensor electrode and the transparent conductive layer of the trace to each other after the transparent conductive layer and the metal layer forming the trace are not formed in the same pattern, but the transparent conductive layer is partially exposed.

Referring to FIG. 5, a sensor electrode 112 and a transparent conductive layer 212 of a trace are formed on a substrate 152. A metal layer 222 which has narrower width than a transparent conductive layer 212 is formed on the transparent conductive layer 212.

The insulation layer 162 formed on the sensor electrode 112 and the trace is patterned to cover the metal layer 222 of the trace and to expose the transparent conductive layer 212.

The trace bridge electrode 142 is formed to electrically connect the sensor electrode 112 and the transparent conductive layer 212 of the trace through the patterned portion of the insulation layer 162.

It is also possible to combine the structure of the trace as shown in FIG. 5 and the structure of the trace bridge electrode as shown in FIG. 4.

Referring to FIG. 6, the transparent conductive layer 213 and the metal layer 223 of the trace are formed in different patterns to expose the transparent conductive layer 213, and then the trace bridge electrode 143 is formed to connect the sensor electrode 113 and the transparent conductive layer 213 of the trace through the hole of the insulation layer 163.

Now, a method for preparing a touch sensor according to an embodiment of the present invention will be described in detail.

According to the present invention, since the trace bridge electrode for connecting to the sensor electrode is formed together with the sensor bridge electrode by the process of patterning the sensor bridge electrode, a flexible touch sensor with improved bending characteristics and durability that can withstand the stress generated in the bent portion of the touch sensor can be manufactured without additional process steps.

The touch sensor of the present invention can be formed directly on a substrate. Alternatively, procedures for forming a touch sensor can be carried out on a carrier substrate, the carrier substrate can be separated thereafter, and then a base film can be attached.

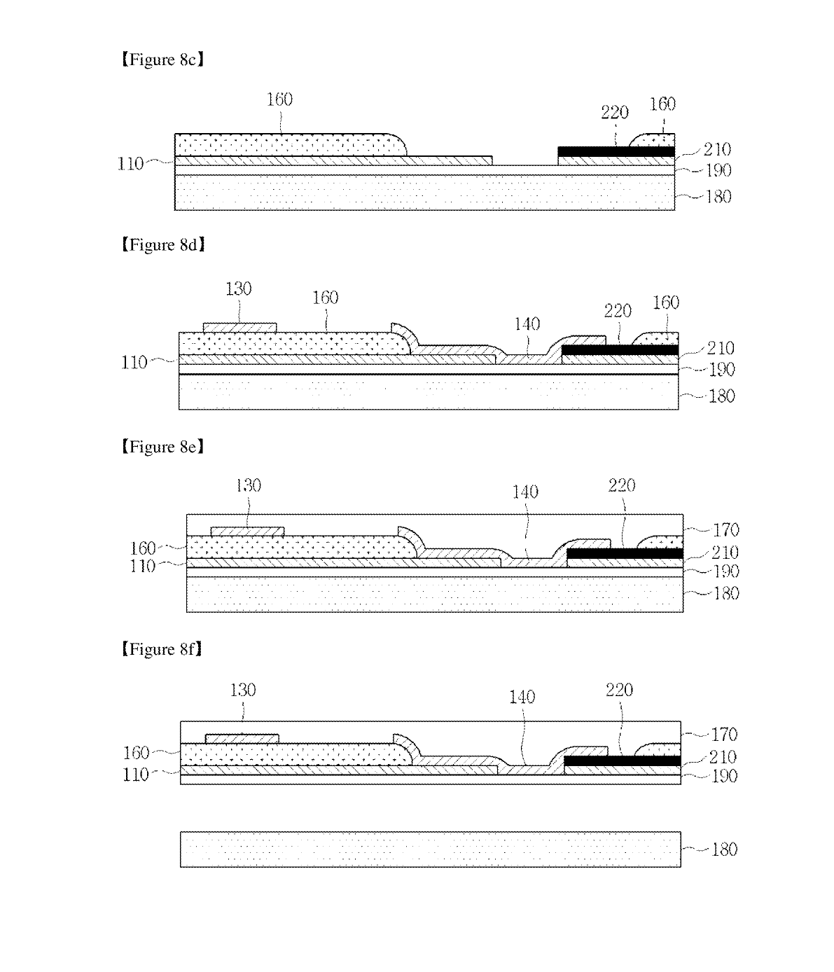

First, a method of forming a touch sensor directly on a substrate will be described. FIGS. 7a to 7e are cross-sectional views showing a method of preparing a touch sensor according to an embodiment of the present invention.

As shown in FIG. 7a, a transparent conductive layer is formed on the substrate 150 and patterned to form a sensor electrode 110 and a transparent conductive layer 210 of a trace. Patterning of the transparent conductive layer may be performed through a photolithographic process using a photosensitive resist.

The transparent conductive layer may be formed by a sputtering method, e.g., chemical vapor deposition (CVD), physical vapor deposition (PVD), plasma enhanced chemical vapor deposition (PECVD); a printing method, e.g., screen printing, gravure printing, reverse offset, ink jet; or a wetting or drying plating method. Particularly, the sputtering may be carried out on a mask disposed on a substrate to form an electrode pattern layer, the mask having the desired electrode pattern shape. Also, after forming a conductive layer on a whole substrate by the above-mentioned methods, electrode patterns may be formed by photolithography.

As the photosensitive resist, a negative-type photosensitive resist or a positive-type photosensitive resist may be used.

Next, as shown in FIG. 7b, a metal layer 220 of the trace is formed. The metal layer 220 may be deposited by a process such as CVD, PVD, or PECVD, but the present invention is not limited thereto.

The metal can be any one of gold, silver, copper, molybdenum, aluminum, palladium, neodymium, platinum, zinc, tin, titanium and alloys thereof.

Now, as shown in FIG. 7c, an insulation layer 160 is applied and patterned.

The application of the insulation layer 160 may be carried out by a conventional coating method known in the art. For example, spin coating, die coating, spray coating, roll coating, screen coating, slit coating, dip coating, gravure coating and the like may be mentioned.

The insulation layer 160 is patterned to expose a portion of the metal layer 220 of the trace and the sensor electrode 110 to electrically connect the sensor electrode 110 and the metal layer 220 of the trace located at the boundary of the active area.

The insulation layer 160 also serves to electrically isolate the first sensor electrode 110 (FIGS. 1 and 3) and the second sensor electrode 120 (FIG. 1). To this end, the insulation layer 160 may be patterned to cover the first and second sensor electrodes 110 and 120 entirely and have holes for the formation of sensor bridge electrodes, or the insulation layer 160 may be patterned to form islands on the connection of a plurality of the first sensor electrodes 110.

Now, as shown in FIG. 7d, the conductive material is patterned to form the sensor bridge electrode 130 and the trace bridge electrode 140.

Since the sensor bridge electrode 130 or both the sensor bridge electrode 130 and the trace bridge electrode 140 may be located on the display area, it is preferable that the bridge electrodes 130 and 140 are formed of a transparent conductive material in order to reduce the visibility of the bridge electrodes 130 and 140. The transparent conductive material used for forming the bridge electrodes 130 and 140 can be a material similar to the material for forming the sensor electrode described above. In particular, it is preferable to limit the difference in transmissivity between the sensor electrode 110 and the bridge electrodes 130 and 140 on the display area to 10% or less in terms of visibility.

Next, as shown in FIG. 7e, after forming the sensor bridge electrode 130 and the trace bridge electrode 140, a passivation layer 170 is formed on the entire surface.

On the other hand, touch sensors according to other embodiments of the present invention shown in FIGS. 4 to 6 can be manufactured by performing the above-described basic process in a similar manner and patterning differently in the metal layer forming step of the trace, the insulation layer forming step, or both of the above steps.

Also, to overcome the process difficulties when using a flexible substrate to implement a flexible touch sensor, a touch sensor may be prepared by carrying out procedures on a carrier substrate and then transferring to a flexible film substrate.

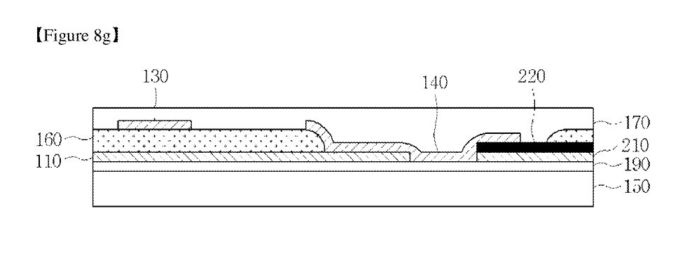

FIGS. 8a to 8g are sectional views showing a method of preparing a touch sensor according to another embodiment of the present invention, which is carried out using a carrier substrate.

First, as shown in FIG. 8a, a separation layer 190 is formed on a carrier substrate 180, and a transparent conductive layer is formed thereon and patterned to form a sensor electrode 110 and a transparent conductive layer 210 of a trace.

The carrier substrate 180 may be a glass, but the present invention is not limited thereto. That is, other kinds of substrates may be used as the carrier substrate 180 if they are heat-resistant materials that can endure a process temperature for electrode formation and maintain planarization without deformation at a high temperature.

When the carrier substrate 180 is used, the layers constituting the touch sensor are formed and then separated from the carrier substrate 180. For this purpose, the separation layer 190 is first formed on the carrier substrate 180, and a transparent conductive layer pattern including the sensor electrode 110 and the transparent conductive layer 210 of the trace is formed thereon.

The separation layer 190 may be made of an organic polymer, for example, at least one selected from the group consisting of polyacrylate, polymethacrylate (e.g., PMMA), polyimide, polyamide, poly vinyl alcohol, polyamic acid, polyolefin (e.g., PE, PP), polystyrene, polynorbornene, phenylmaleimide copolymer, polyazobenzene, polyphenylenephthalamide, polyester (e.g., PET, PBT), polyarylate, cinnamate polymer, coumarin polymer, phthalimidine polymer, chalcone polymer and aromatic acetylene polymer.

The application of the composition for forming the separation layer may be carried out by a conventional coating method known in the art, for example, spin coating, die coating, spray coating, roll coating, screen coating, slit coating, dip coating, gravure coating and the like. After coating, the separation layer 190 is subject to curing by way of thermal curing or UV curing. These thermal curing and UV curing may be carried out alone or in combination thereof.

The process of forming the sensor electrode 110 and the transparent conductive layer 210 of the trace on the separation layer 190 is similar to that described above with reference to FIG. 7a.

Next, as shown in FIGS. 8b to 8e, a metal layer 220 of the trace, an insulation layer 160, bridge electrodes 130 and 140, and a passivation layer 170 are formed in this order. The forming steps thereof are similar to those described above with reference to FIGS. 7b to 7e, and thus a detailed description thereof will be omitted.

Then, as shown in FIG. 8f, the separation layer 190 on which the electrode is formed is separated from the carrier substrate 180 used for carrying out a preparation process of the touch sensor. The separation layer 190 can be separated from the carrier substrate 180 by physical peeling. Examples of the peeling method may include lift-off and peel-off, without limitation.

For the peeling, a force of 1 N/25 mm or less, preferably 0.1 N/25 mm or less may be applied, and the force may be varied depending on the peeling strength of the separation layer. If the peeling strength exceeds 1 N/25 mm, the film touch sensor may be broken during peeling from the carrier substrate and an excessive force may be applied to the film touch sensor, thereby causing the deformation of the film touch sensor and failing to function as a device.

Next, the flexible film substrate 150 is attached to the surface of the separation layer 190 from which the carrier substrate 180 is peeled off. As the film substrate 150, various films as described above can be used.

Although not shown in the drawings, the substrate 150 may be adhered onto the passivation layer 170 opposite to the surface of the separation layer 190 from which the carrier substrate 180 is peeled off, if necessary.

Also, although not shown in the drawings, a protective layer may be formed by using an organic insulation layer or an inorganic insulation layer on the separation layer 190, if necessary.

Thereafter, the film touch sensor may be attached with a circuit board, in which a conductive adhesive may be used for attachment with the circuit board.

The conductive adhesive refers to an adhesive having a conducting filler such as silver, copper, nickel, carbon, aluminum and gilded gold dispersed in a binder of epoxy, silicon, urethane, acrylic or polyimide resin.

The attachment of the circuit board may be carried out before or after the touch sensor is separated from the carrier substrate.

The touch sensor thus manufactured can be attached to a display panel. At this time, a polymer material such as optically clear adhesive (OCA) can be applied, and then the touch sensor can be bonded through photo-curing and thermal curing.

The OCA is a film type adhesive that applies physical force, which can be used by entire adhesion or border adhesion.

Although particular embodiments and examples of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

### DESCRIPTION OF REFERENCE NUMERALS

100: active area
110, 111, 112, 113: first sensor electrode
120: second sensor electrode
130, 131, 132, 133: sensor bridge electrode
140, 141, 142, 143: trace bridge electrode
150, 151, 152, 153: substrate
160, 161, 162, 163: insulation layer
170, 171, 172, 173: passivation layer
180: carrier substrate
190: separation layer
200: trace
210, 211, 212, 213: transparent conductive layer
220, 221, 222, 223: metal layer

1. A touch sensor comprising:
a substrate;
an active area in which sensor electrodes are arranged on the substrate;
a trace located on a boundary of the active area on the substrate to connect the sensor electrodes to a touch sensor wiring; and
at least one trace bridge electrode electrically connecting the sensor electrodes to the trace.

2. The touch sensor according to claim 1, wherein
the sensor electrodes include a plurality of first sensor electrodes arranged in a first direction and connected with each other in one pattern and a plurality of second sensor electrodes arranged in a second direction crossing the first direction and connected with each other via sensor bridge electrodes.

3. The touch sensor according to claim 1, wherein
the trace includes a transparent conductive layer made of the same material as the sensor electrodes; and a metal layer, and
the trace bridge electrode electrically connects the sensor electrodes with the transparent conductive layer or electrically connects the sensor electrodes with the metal layer.

4. The touch sensor according to claim 1, wherein
the difference in transmissivity of the trace bridge electrode and the sensor electrodes is 10% or less.

5. The touch sensor according to claim 1, wherein
the touch sensor has a bent shape to form a curved surface around at least a part of the trace.

6. A method for preparing a touch sensor comprising the steps of:
forming a first conductive pattern including a sensor electrode pattern and a first trace pattern on a substrate;
forming a second trace pattern on at least a part of the first trace pattern;
applying and patterning an insulation layer for covering at least one of the first conductive pattern and the second trace pattern; and
forming a trace bridge electrode electrically connecting at least a part of the sensor electrode pattern to the first or the second trace pattern on the insulation layer.

7. A method for preparing a touch sensor comprising the steps of:
forming a separation layer by applying a composition for forming the separation layer on a carrier substrate;
forming a first conductive pattern including a sensor electrode pattern and a first trace pattern on the separation layer;
forming a second trace pattern on at least a part of the first trace pattern;
applying and patterning an insulation layer for covering at least one of the first conductive pattern and the second trace pattern; and
forming a trace bridge electrode electrically connecting at least a part of the sensor electrode pattern to the first or the second trace pattern on the insulation layer.

8. The method for preparing a touch sensor of claim 6, wherein
the sensor electrode pattern includes a plurality of first sensor electrodes arranged in a first direction and connected with each other in one pattern and a plurality of second sensor electrodes arranged in a second direction crossing the first direction and unconnected with each other, and
the sensor bridge electrodes for connecting the plurality of the second sensor electrodes with each other are formed in the step of forming the trace bridge electrode.

9. The method for preparing a touch sensor of claim 6, further comprising the step of forming a passivation layer after the step of forming the trace bridge electrode.

10. The method for preparing a touch sensor of claim 7, further comprising the step of removing the carrier substrate and attaching a base film after the step of forming the trace bridge electrode.

11. The method for preparing a touch sensor of claim 7, wherein
the sensor electrode pattern includes a plurality of first sensor electrodes arranged in a first direction and connected with each other in one pattern and a plurality of second sensor electrodes arranged in a second direction crossing the first direction and unconnected with each other, and
the sensor bridge electrodes for connecting the plurality of the second sensor electrodes with each other are formed in the step of forming the trace bridge electrode.

12. The method for preparing a touch sensor of claim 7, further comprising the step of forming a passivation layer after the step of forming the trace bridge electrode.
